(19) United States
(12) Patent Application Publication
(10) Pub. No.: US 2009/0255371 A1
(43) Pub. Date: Oct. 15, 2009

(54) METHOD FOR OBTAINING VALUABLE PRODUCTS

(75) Inventors: Eberhard Krause, Hohen Neuendorf (DE); Valentin Rohm, Munchen (DE)

Correspondence Address: BARLOW, JOSEPHS & HOLMES, LTD., 101 DYER STREET, 5TH FLOOR, PROVIDENCE, RI, 02903, US

(73) Assignee: KRAUSE-ROHM-SYSTEME AG, Munchen (DE)

(21) Appl. No.: 12/298,567

(22) PCT Filed: Apr. 25, 2007
(86) PCT No.: PCT/EP07/54058

§ 371 Date: Oct. 27, 2008

(30) Foreign Application Priority Data
May 4, 2006 (DE) 10 2006 020 841.2

(51) Int. Cl. C22B 7/00; C22B 3/00

(52) U.S. Cl. 75/10.67; 75/392

(57) ABSTRACT

The invention relates to a method for obtaining valuable products using red mud, which accumulates during the manufacture of aluminum by the Bayer method. The method according to the invention comprises the steps: a) reduction of at least one part of the iron(III) oxide and/or iron(III) hydroxide using at least one reductant that contains at least one hydrocarbon; and b) separation of at least one solid phase of the reaction mixture from at least one liquid and/or gaseous phase, the solid and/or liquid and/or gaseous phase comprising at least one valuable product that at least contains magnetite and the reductant comprising methane and/or natural gas and/or ethanol and/or carbon.

### PRIOR ART

Red mud develops in aluminum production according to the Bayer method. Chemically considered, red mud is a mixture mainly composed of iron(III) oxides or hydroxides, respectively, titanium oxides, alumina residues, quartz sand, calcium oxide, sodium oxide and caustic soda lye. The name red mud originates from its red color caused by iron(III) oxide. The processing of the red mud is aggravated by the particles of the red mud having a very small diameter on average in the range between 0.1 and 1 μm conditioned by the production process. Particularly, separation of the iron(III) oxide from the remaining silicates, aluminates and oxides presents a complex technical problem and was not resolved heretofore in satisfactory manner.

To each produced ton of aluminum, according to the quality of the used bauxite, 0.5-1.5 tons of red mud arise as a non-avoidable attendant. The amount arising therein each year is several millions of tons and presents a serious problem together with the already present red mud. Since red mud is substantially regarded as a waste product heretofore, it is largely unutilized disposed of by storage in sealed disposal sites. Therein, the only utilization is in the recovery of the caustic soda lye depositing on the disposal site floor and the recycling thereof into the Bayer method. This form of disposal also results in substantial financial problems besides problems of environmental protection. The storage in disposal sites is costly and expensive, since large areas and plants are required and high cost arise for the transport of the red mud. Additionally, the long-term cost incurred by the deposition can only difficultly be calculated and present an additional economical problem.

Therefore, numerous attempts have been made in order to convert the red mud regarded as a waste product heretofore into usable valuable products and supply to economic utilization. Therein, each advantageous approach should exploit the potential contained in the red mud as much as possible and offer an extensive utilization of the included components. A newer method by Virotec International LTD, protected as “Basecon™ Technology”, achieves a reduction of the pH value to about 9 by conversion of red mud with sea water, and thereby opens various possibilities of application for the dealkalized red mud such as the employment as a flocculating agent or its use as a treating agent for acidic wastewaters or acidic soils, respectively.

The circumstance that the use of about 1 million of tons annually within the scope of this method corresponds to less than 2% of the annual production and thus it is not suitable for coping with the annually arising amount of red mud, and especially does not present any solution for the already deposited red mud waste, is to be considered disadvantageous in this method. Furthermore, it is to be considered disadvantageous that wide use of the various valuable products contained in the red mud does not occur, and thus only a fraction of the present economical and ecological potential is exploited.

Therefore, the object of the present invention is to provide a large-technically realizable method for utilization of red mud as extensive as possible, which is employable both for the annually arising and the already deposited red mud.

### PRESENTATION OF THE INVENTION

According to the invention, the object is solved by a method for obtaining valuable products by means of red mud having the features of claim 1.

Advantageous developments with convenient and non-trivial further developments of the invention are described in the further claims.

According to the invention, red mud is employed in a method for obtaining valuable products including the following steps: a) reduction of at least one part of an iron(III) oxide and/or iron(III) hydroxide contained in the red mud with at least one reductant including at least hydrocarbon, and b) separation of at least one solid phase of the reaction mixture from at least one liquid and/or gaseous phase, wherein the solid and/or the liquid and/or the gaseous phase includes at least one valuable product including at least magnetite, and wherein the reductant includes methane and/or natural gas and/or ethanol and/or carbon. Such a method offers various advantages. Besides silicates, titanium oxides, residual caustic soda lye and various other compounds, red mud contains iron(III) oxide or hydroxide as the main component, respectively, in the form of hematite and goethite with a weight fraction between 30 and 60%. Therefore, red mud ideally lends itself for obtaining valuable products by reduction of the included iron(III) components. Therein, the circumstance is to be regarded as advantageous that the reductant itself is oxidized to valuable products. Depending on the selected reductant, synthesis gas, ethene or acetaldehyde develops upon the reaction with iron(III) oxide or iron(III) hydroxide, respectively, which in turn present important valuable products as central starting components of various chemical reactions. Therein, methane offers the advantage that it is virtually worldwide available in great amounts and allows a very inexpensive conduction of reaction. The employment of natural gas offers the advantage that the method can also be economically performed in remote natural gas deposits such as for example Alaska. Advantageously, the natural gas is additionally desulphurized during the method. The use of alcohol as a reductant is also to be regarded as advantageous especially under environmental protection aspects, because the conversion of a product categorized as waste heretofore thus is allowed with the aid of a regrowing raw material, and additionally provides the valuable product acetaldehyde versatile employable in the chemical industry. Since alumina factories producing red mud in processing bauxite to alumina usually employ carbon-fired boilers for the heating steam production, carbon as hydrocarbon containing reductant offers the advantage that the transport amount just has to be correspondingly increased. In countries such as Australia or Brasilia, where cheap hard coal of high quality is available in virtually unlimited manner, thus, significant reduction of the process cost is achieved in employment of carbon as a reductant.

Therein, for example, the reaction can be conducted in a continuous-flow reactor. However, other suitable reactor devices such as rotary kilns are also conceivable. After completion of the reduction which can be easily determined by the color change from red (Fe₂O₃) to black (Fe₃O₄), depending on the selected hydrocarbon and the selected reduction conditions, at least one solid phase consisting of reaction products and residual red mud, as well as a liquid and/or gaseous phase are present. Therein, at least one of these phases incorporates a valuable product obtained by the reduction. Therein, above all, the valuable iron ore magnetite is to be mentioned as the valuable product, which is present in the solid and/or liquid phase together with residual oxides, aluminates and silicates. Thus, red mud presents a valuable source for iron ore in times of increasing raw material shortage, which especially is required in iron processing for producing steels. Therein, the concentration of pure magnetite with at least 90% is about two times as high as that in the high-grade natural ore. If one considers not only the annually arising amounts of red mud, but also the many millions of tons of already deposited red mud, the importance of the method as a simple and inexpensive possibility for ecologically and economically advantageously obtaining iron ore becomes clear. The separation of the solid from the liquid and/or gaseous phase is performed in simple manner with the aid of a gas separator and/or solid separator coupled to the reactor. However, other separating processes such as for example flotation separating processes are also conceivable.

In an advantageous development of the method according to the invention, it is provided that the gaseous phase separated in step b) includes at least carbon monoxide and/or hydrogen. Particularly in combination with the already mentioned use of methane and/or natural gas and/or carbon as the reductant, the method also provides synthesis gas (CO+H₂) as an additional valuable product in the gaseous phase besides magnetite. Compared to synthesis gas formed by other conceivable educts, the synthesis gas developing in the conversion of methane has the highest proportion of hydrogen in relation to carbon monoxide. Thereby, it particularly lends itself as a starting component of various important chemical reactions such as for example the methanol synthesis or the conversion of alkenes into aldehydes extended by a methylene group according to the so-called oxo synthesis.

In another advantageous development of the method according to the invention, it is provided that the method includes an additional step c) after step b), which incorporates separation of the separated solid phase into at least a first magnetizable and a second non-magnetizable component, wherein the first component includes at least magnetite and the second component includes at least one oxide and/or silicate. Therein, the circumstance is to be regarded as advantageous that in this manner, decomposition of red mud into a magnetizable iron ore and a non-magnetizable low-iron residual mineral stock and thus extensive utilization of the various red mud components is permitted. In another advantageous development of the invention, it is provided that the additional method step c) includes the use of at least one magnetic separator. Since magnetite has a spinel structure AB₂O₄, in which iron(II) ions occupy the octahedral places and iron(III) ions occupy the tetrahedral places, it is ferromagnetic and greatly magnetizable. With the aid of a magnetic separator, thus, there can be provided a technically particularly simple and inexpensive possibility to separate the red mud virtually quantitatively into magnetizable iron ore and non-magnetizable low-iron components.

In another advantageous development of the method according to the invention, it is provided that the method includes the following additional step d) after step b) and/or optionally c), wherein step d) consists in cleaning of the gaseous phase and includes cleaning, preferably removing CO₂ from the gaseous phase. This step advantageously ensures that the synthesis gas separated in step c) is optimally matched to the requirements of potential further processing methods. Therein, the cleaning steps preferably includes removal of CO₂ from the gaseous phase, which is related to carbon monoxide via the general equation

CO₂+C←→2 CO

However, other measures for cleaning the gaseous phase such as for example water removal and drying, soot separation, desulphurization or measures for adjusting the desired CO:H₂ ratio are also conceivable.

In another advantageous development of the invention, it is provided that the cleaning in step d) includes the use of a modified Benfield™ process. Therein, the separated gaseous phase is liberated from CO₂, H₂S and other acidic components by means of warm potassium carbonate solution in a cyclic process. In this method, the circumstance is to be regarded as advantageous that in one step, removal of undesired CO₂ and desulphurization of the gaseous phase is performed. Another advantage is the low solubility of the synthesis gas to be cleaned in the used potassium carbonate solution. Additionally, the modified Benfield™ process exclusively includes starting compounds, which can be obtained worldwide at low cost.

In another advantageous development of the method according to the invention, it is provided that the method includes the following additional step e) after step b) and/or optionally step c) and/or d), which incorporates conduction of a hydrocarbon synthesis process, especially a Fischer-Tropsch and/or a gas to liquids process, wherein at least one educt of the synthesis includes at least one component originating from the gaseous phase separated in step b), at least one product includes at least one hydrocarbon, and wherein the synthesis process includes use of at least one catalytically active component. The Fischer-Tropsch process is a large-technical process for converting synthesis gas (CO/H₂) into liquid hydrocarbons. The general mechanism can be described with the following formula:

n CO+(2n+1)H₂→CₙH₂ₙ₊₂+n H₂O

Usually, the reaction proceeds catalytically accelerated under pressure at temperatures between 200° C. and 350° C. and first of all provides gasoline and oils besides paraffins, alkenes and alcohols. Particularly with regard to the declining crude oil deposits, this presents an important alternative synthesis way for obtaining fuel. By fractionation, among other things, high-grade fuel for diesel engines can be obtained from the obtained hydrocarbons. It has the advantage of being colorless and odorless, completely free from sulfur and free from aromatic or organic nitrogen compounds. Additionally, it is biologically degradable and non- toxic. If the synthesis gas obtained by reduction of the iron(III) fraction should not have the hydrogen proportion required for performing the Fischer-Tropsch process, it can be admixed afterwards. Another advantageous possibility of obtaining additional valuable products is the conductance of a gtl process (gas to liquids) in combination with the use of natural gas as a reductant in step a). Therein, first, natural gas is converted to synthesis gas by supply of oxygen, which is further processed to liquid hydrocarbon in the above described manner. The mentioned advantages of the Fischer-Tropsch products therefore also apply to gtl products. As catalysts suitable for the Fischer-Tropsch process, among other things, various cobalt and iron catalysts are described in the literature.

In another advantageous development of the method according to the invention, it is provided that at least one component of the red mud itself is the catalytically active component. Magnetite is known to the person skilled in the art as a particularly effective catalyst for performing a Fischer-Tropsch process. Therefore, advantageously, it is provided that magnetite produced by reduction of the iron(III) fraction of red mud in step a) and separated in step b) and/or c) is used as the catalytically active component of the Fischer-Tropsch process. Thereby, conversion of red mud within the scope of the method according to the invention allows the access to various further valuable products and presents a beneficial, extensive, ecologically and economically important possibility of utilization of the red mud regarded as waste heretofore.

Another aspect of the invention relates to the use of a second, non-magnetizable component separated in step c) according to claim 3 as at least one cement addition material. Therein, the low-iron residual mineral stock obtained after the separation of magnetite advantageously lends itself as a cement addition material, which otherwise would not be possible due to the complex reactions conditioned by the high iron content of red mud, which are referred to as corrosion. The additional addition of a certain mass proportion of calcium carbonate (limestone) is also conceivable. In this manner, the mineral formation is promoted and provides a hydraulic cement. Additionally, potentially present alkaline components are incorporated in silicates in large part by side reactions, such that the final product has a weakly alkaline pH value in the range between 7 and 9. The use of the residual mineral stock thus offers the complete utilization of all of the components of red mud together with the already described possibilities of utilization. In this manner, the requirement of disposal and especially of storage of the red mud in disposal sites is eliminated. Not only enormous savings by the elimination of the cost related to deposition, but on the contrary special advantages by the economical utilization of the produced valuable products are associated therewith.

Another aspect of the invention relates to the use of at least one component originating from the gaseous phase separated in step b) according to claim 1 as an educt for performing a hydrocarbon synthesis process, especially a Fischer-Tropsch and/or a gas to liquid process, wherein at least one product includes at least one hydrocarbon and wherein the synthesis process includes use of at least one catalytically active component. The advantages realized thereby can already be taken from the preceding descriptions of advantages.

In another advantageous development of the use according to the invention, it is provided that at least one component of the red mud itself is the catalytically active component. As already mentioned, magnetite is known to the person skilled in the art as a particularly effective catalyst for performing a Fischer-Tropsch process. Therefore, it is advantageously provided that magnetite produced by reduction of the iron(III) fraction of red mud in step a) and separated in step b) and/or c) is used as the catalytically active component of the Fischer-Tropsch process.

Further advantages, features and details of the invention are apparent from the following descriptions of several embodiments.

### EXAMPLE 1

Dried red mud with a water content below 5% is subjected to a reduction of the iron(III) salts to magnetite. Therein, the reduction to magnetite is effected by leading-over methane at a temperature between 250° C. and 800° C. The separation of the solid from the gaseous phase is effected after completion of the reduction with the aid of a solid separator. Therein, the end of the reaction can be determined in simple manner by the color change from red (Fe₂O₃) to black (Fe₃O₄). The subsequent separation of the solid phase into a magnetizable and a non-magnetizable phase is performed in simple manner with the aid of a magnetic separator. Therein, magnetite is separated from the remaining mineral mixture and can be further processed in known manner. The remaining mineral mixture is mixed with 10% calcium carbonate (w/w) and used as a cement addition material.

### EXAMPLE 2

Red mud with a water content below 20% is subjected to a reduction of the included iron(III) oxides and iron(III) hydroxides to magnetite. Therein, the reduction to magnetite is effected by leading-over methane, natural gas or ethanol under sub-stoichiometric conditions at temperatures between 650 and 1100° C. in a fluidized-bed reactor. In this reaction stage, the non-magnetic iron(III) oxides and hydroxides are virtually completely reduced to magnetite. Additionally, carbon particles acting in reducing manner form due to the relative deficiency of oxygen. The gaseous reaction products include particularly CO besides H₂O and CO₂, wherein the equilibrium appearing according to the endothermic Boudouard reaction

CO₂+C←→2 CO

can be shifted to the product side according to the principle of Le Chatelier by temperature increase or by pressure decrease, respectively. Thus, for example, at a temperature of 1000° C. and a pressure of 10⁵ Pa, a yield of at least 98% CO is achieved. At a reduced temperature between 650 and 700° C., the yield of CO decreases below 50%. Additionally, hydrogen develops in side reactions of the pyrolysis with catalytic action of the activated iron oxides.

Subsequently, the gaseous phase is separated from the solid phase including magnetite and cleaned, wherein especially the developed CO₂ is removed. Therein, the cleaning is effected with the aid of a modified Benfield™ process. The cleaned CO and H₂ rich gas is subsequently again returned into the reduction process and employed for further reduction of the iron(III) oxide and iron(III) hydroxide in the cycle.

The separated solid phase including the magnetic iron ore magnetite as well as secondary titanium iron ore components is separated from the non-magnetic residual mineral stock after cooling with the aid of a magnetic separator. Above all, it contains a mixture containing aluminosilicates of alumina and quartz sand (10%) with small fractions of lime (3%). It can for example be employed as a cement addition material, as a soil improver or as mineral fertilizer, since the clay minerals are crucial for the water retention of soils. The water retention of soils is an aspect which is particularly important for the bauxite mining countries, because the destruction of soil in tropic countries is just also contributory caused by washing-out the clay minerals.

### EXAMPLE 3

Dehydrated red mud is converted with natural gas as an inexpensive reductant at temperatures between 230 and 650° C. under oxygen shut-off as previously described. Therein, the reaction includes a catalytic partial oxidation at moderate temperatures, wherein particularly iron(III) oxides are reduced and methane oxidizes to carbon monoxide CO and hydrogen H₂ according to the equation:

CH₄+Fe₂O₃/FeO(OH)→CO+2 H₂+Fe₃O₄

in a reforming process. Thereby, in process further reducing gases develop, the excess of which can be used as a fuel gas or in other chemical processes and presents a valuable by-product. At the same time, carbon dioxide and water are formed in side reactions. Heat has to be supplied to the reaction since the main reaction is endothermic.

For economical reasons, the process is continuously carried out in a continuous-flow reactor. The hot mineral mixture is for example discharged through a screw extruder and conducted over a heat exchanger section for recovering heat for the dehydration. Thereafter, the mineral particles bound together are again squeezed to the finest milled starting product between rollers. Proceeding mineralizing processes during development of magnetite provide for improved phase separation by the magnetic separator provided in the next stage and prevent the magnetic or non-magnetic mineral particles from getting caught.

At the end, magnetite and separated from it a mixture of basic clay minerals with lime and quartz sand are obtained, which is further used as already described. The yield of magnetite is at least 75% and can be increased up to 95% by measures usual in the art.

### EXAMPLE 4

Red mud from bauxite decomposition contains iron oxides/hydroxides in the form of the minerals hematite Fe₂O₃ and goethite FeO(OH) in 42-50% (w/w), clay minerals of the aluminosilicate group with >30% (w/w), SiO₂ in amounts between 5 and 10% (w/w) as well as lime from the recovery of caustic soda lye in 3-5% (w/w). The water content of the red mud usually is between 25 and 40% (v/w). Obtaining the iron oxides and the titanium as ilmenite is possible in simple manner if the oxides/hydroxides of the metals present in the red mud are exposed to a thermal treatment at temperatures of at least 750° C. to max. 1100° C. under reducing conditions. Therein, ilmenite develops from rutile (TiO₂) and the iron compounds. The iron minerals are converted to the thermodynamically most stable compound magnetite. These two minerals can be easily separated from the non-magnetic residue with known techniques due to their strongly magnetic characteristic. Known flotation techniques can also be used for separation.

In the present embodiment, the method is performed with pulverized carbon as the reductant. For performing, red mud is mixed with 3-20% (w/w) pulverized carbon in a pre-mixer and guided to a rotary kiln over a drying section preheated with waste heat. The redox reactions continuously occur in this furnace optionally with or without aid of a supporting fire. Alumina factories usual at present dispose of calcination furnaces with capacities of up to 8000 t per day. This technology can be employed here without great modification.

Advantageously, the process sequence is designed allothermic since both highly exothermic reactions such as the oxidation of the carbon (C+O₂→CO₂) and endothermic reactions such as the formation of carbon monoxide according to the Boudouard reaction (2 CO←C+CO₂) occur simultaneously. The reduction to magnetite is at least 75% under these conditions, but can be easily increased to 90% and more with measures usual in the art.

Subsequently, the reduced fine powder is transported to a cooling drum with heat exchanger and supplied to a magnetic separator in the next stage after sufficient cooling. It separates the components magnetite and ilmenite (iron titanium ore) due to their highly magnetic characteristics from the non-magnetic residual mineral stock, which essentially includes non-magnetic clay minerals, quartz, lime as well as small amounts of non-magnetic iron ore.

The clay minerals can be employed as a cement addition, since their chemical composition largely corresponds to the materials occurring in cement, and thus so-called iron cement can be produced. By addition of further burnt lime, the hydraulic character of the cement addition can be matched to the respective requirement. Moreover, the non-magnetic mineral residue can be used as a water retainer due to the clay minerals or as a soil improver or mineral fertilizer, respectively, due to the lime and iron content, respectively.

1. Method for obtaining valuable products by means of red mud, which arises in the aluminum production by the Bayer process, including the following steps:
a) reducing at least one part of an iron(III) oxide and/or iron(III) hydroxide contained in the red mud with at least one reductant, which includes at least one hydrocarbon; and
b) separating at least one solid phase of the reaction mixture from at least one liquid and/or gaseous phase, wherein the solid and/or the liquid and/or gaseous phase includes at least one valuable product including at least magnetite,
characterized in that
the reductant includes methane and/or natural gas and/or ethanol and/or carbon.

2. Method according to claim 1,
characterized in that
the gaseous phase separated in step b) includes at least carbon monoxide and/or hydrogen.

3. Method according to claim 1,
characterized in that
the method includes the following additional step after step b):
c) separating the separated solid phase into at least a first magnetizable and a second non-magnetizable component, wherein the first component includes at least magnetite and the second component includes at least one oxide and/or silicate.

4. Method according to claim 3,
characterized in that
step c) includes use of at least one magnetic separator.

5. Method according to claim 1,
characterized in that
the method includes the following additional step after step b) and/or optionally c):
d) cleaning the gaseous phase, wherein the cleaning preferably includes the removal of CO₂ from the gaseous phase.

6. Method according to claim 5,
characterized in that
the cleaning includes a modified Benfield process.

7. Method according to claim 1,
characterized in that
the method includes the following additional step after step b) and/or optionally step c) and/or d):
e) performing a hydrocarbon synthesis process, especially a Fischer-Tropsch and/or a gas to liquid process, wherein at least one educt of the synthesis includes at least one component originating from the gaseous phase separated in step b), at least one product includes at least one hydrocarbon, and wherein the synthesis process includes use of at least one catalytically active component.

8. Method according to claim 7,
characterized in that
at least one component of the red mud itself is the catalytically active component.

9. Use of a second, non-magnetizable component separated in step c) according to claim 3 as at least one cement addition material.

10. Use of at least one component originating from the gaseous phase separated in step b) according to claim 1 as and educt for performing a hydrocarbon synthesis process, especially a Fischer-Tropsch and/or a gas to liquid process, wherein at least one product includes at least one hydrocarbon and wherein the synthesis process includes use of at least one catalytically active component.

11. Use according to claim 10,
characterized in that
at least one component of the red mud itself is the catalytically active component.
